(19) United States
(12) Patent Application Publication
(10) Pub. No.: US 2008/0102259 A1
(43) Pub. Date: May 1, 2008

(54) Oxide materials, articles, systems, and methods

(76) Inventors: Anguel N. Nikolov, Los Angeles, CA (US); Ronnie Varghese, Flemington, NJ (US); Jian Jim Wang, Orefield, PA (US); Sebastian Fiorillo, Middlesex, NJ (US)

Correspondence Address: FISH & RICHARDSON PC, P.O. BOX 1022, MINNEAPOLIS, MN, 55440-1022, US

(21) Appl. No.: 11/588,119

(22) Filed: Oct. 26, 2006

(51) Int. Cl. B32B 9/00

(52) U.S. Cl. 428/213; 428/702; 428/336; 423/326; 423/327.1; 501/55; 501/73; 501/154; 501/901

(57) ABSTRACT

This disclosure relates to oxide materials, as well as related articles, systems and methods.

### TECHNICAL FIELD

This disclosure relates to oxide materials, as well as related articles, systems and methods.

### BACKGROUND

Oxides are commonly used in devices and systems where manipulation of electromagnetic (EM) radiation is desired. Examples of EM radiation include the ultra-violet region, the visible region, and the infra-red region. Examples of optical devices include lenses, polarizers, optical filters, antireflection films, optical retarders (e.g., waveplates), and beam splitters (e.g., polarizing and non-polarizing beam splitters).

### SUMMARY

This disclosure relates to oxide materials, as well as related articles, systems and methods.

In one aspect, the invention features an oxide that includes silicon and a metal and the oxide has a refractive index of at least about 1.8 at a wavelength of 632 nm.

In another aspect, the invention features an oxide compound that includes at least about one atomic percent silicon and at least about twenty atomic percent of a metal.

In a further aspect, the invention features an oxide that includes silicon and a metal. The oxide has a thickness defined by first and second surfaces. The oxide includes a first portion partially defined by the first surface of the oxide and a second portion partially defined by the second surface of the oxide. The first portion is different from the second portion. The first portion has a first average atomic percentage of silicon that is greater than zero, the second portion has a second average atomic percentage of silicon that is greater than zero, and the second average atomic percentage is different from the first average atomic percentage of silicon.

In an additional aspect, the invention features an article that includes a first layer of titanium oxide and a second layer of an oxide comprising titanium and silicon.

In yet another aspect, the invention features an article that includes a substrate and a layer of an oxide supported by the substrate. The oxide includes silicon and a metal. The article is an optical component.

In a further aspect, the invention features an article that includes a substrate and a layer of an oxide supported by the substrate. The oxide includes silicon and a metal and has a refractive index greater than a refractive index of silicon oxide and less than a refractive index of metal oxide. The article is an optical element.

In an additional aspect, the invention features a system that includes an optical element. The optical element includes a substrate and a layer of an oxide that includes silicon and a metal supported by the substrate.

In yet another aspect, the invention features a system that includes an optical element. The optical element includes a substrate and a layer of an oxide supported by the substrate. The oxide includes silicon and a metal and has a refractive index greater than a refractive index of silicon oxide and less than a refractive index of metal oxide.

In a further aspect, the invention features a method that includes forming an approximately amorphous oxide that includes silicon and a metal using gas phase deposition wherein the oxide is formed at a temperature of at least about 190 degrees Celsius.

In an additional aspect, the invention features a method that includes forming an oxide that includes silicon and a metal using atomic layer deposition. The oxide is formed at a temperature of at least about 190 degrees Celsius.

Embodiments can feature one or more of the following.

In certain embodiments, the oxide has a refractive index of at least about 2.0 (e.g., at least about 2.2, at least about 2.5) at a wavelength of 632 nm. In some embodiments, the metal is one of titanium, hafnium, aluminum, niobium, zirconium, tantalum, magnesium, neodymium, tin, vanadium, and yttrium. In certain embodiments, the oxide includes at least about one atomic percent silicon (e.g., at least about five atomic percent silicon). In some embodiments, the oxide includes at most about twenty atomic percent silicon (e.g., at most about ten atomic percent silicon, at most about five atomic percent silicon). In certain embodiments, the oxide includes at least about twenty atomic percent of the metal (e.g., at least about twenty-five atomic percent of the metal). In some embodiments, the oxide includes at most about thirty atomic percent of the metal (e.g., at most about twenty-five atomic percent of the metal).

In some embodiments, the metal is titanium and the oxide includes at least about fifteen atomic percent titanium and at least about one atomic percent silicon. In certain embodiments, the oxide comprises at most about thirty atomic percent titanium. In some embodiments, the oxide comprises at most about ten atomic percent silicon (e.g., at most about five atomic percent silicon).

In certain embodiments, the oxide has first and second surfaces that define a thickness of the oxide, and the thickness of the oxide is at least about 5 nm (e.g., at least about 25 nm, at least about 50 nm, at least about 80 nm, at least about 100 nm. In some embodiments, the oxide is at least about 90 percent amorphous.

In certain embodiments, the oxide has a thickness defined by first and second surfaces, the oxide includes a first portion partially defined by the first surface of the oxide, and the oxide includes a second portion partially defined by the second surface of the oxide. In some embodiments, the first portion is different from the second portion, the first portion has a first average atomic percentage of silicon that is greater than zero, the second portion has a second average atomic percentage of silicon that is greater than zero, and the second average atomic percentage is different from the first average atomic percentage of silicon. In some additional embodiments, the first portion has a first average atomic percentage of silicon that is equal to zero and the second portion has a second average atomic percentage of silicon that is greater than zero. In some additional embodiments, the first portion has a first average atomic percentage of silicon, the second portion has a second average atomic percentage of silicon, and the second average atomic percentage is different from the first average atomic percentage of silicon.

In some embodiments, the difference between the first average atomic percentage and the second average atomic percentage is at least about five percentage (e.g., at least about ten percentage, at least about twenty percentage). In certain embodiments, the first average atomic percentage is at least about one percentage (e.g., at least about three percentage). In some embodiments, the first average atomic percentage is at most about ten percentage (e.g., at most about five percentage). In some embodiments, the second average atomic percentage is at least about ten percentage (e.g., at least about twenty percentage).

In some embodiments, the article can include a third layer of titanium oxide supported by the second layer. In certain embodiments, the article can include a fourth layer of an oxide comprising titanium and silicon supported by the third layer. In some embodiment, the article can include a fifth layer of titanium oxide supported by the fourth layer. In certain embodiments, the article can include a sixth layer of an oxide comprising titanium and silicon supported by the fifth layer.

In some embodiments, the optical component is a thin film interference filter, an absorption filter, a wire grid light polarizing structure, a rugate filter, a conformal filling of a three-dimensional structure, a conformal film growth on a three-dimensional template structure, an optical lens structure, and/or an interface layer between different parts of an integrated optical component. In certain embodiments, the three-dimensional structure is a trench, a diffraction grating groove, a pillar, a pyramid, a column, and/or a semi-sphere.

In some embodiments, the method uses chemical vapor deposition. In certain embodiments, the method includes depositing silicon atoms, oxygen atoms, and atoms of the metal. The silicon atoms can be deposited separately from the atoms of the metal and from the oxygen atoms. In some embodiments, the method includes exposing a surface to a precursor comprising silicon atoms. In certain embodiments, the method can include exposing silicon atoms to a precursor comprising oxygen atoms and exposing oxygen atoms to a precursor comprising atoms of the metal. In some embodiments, the method includes alternately depositing atoms of silicon, oxygen and the metal. In certain embodiments, the method includes forming a monolayer of oxygen, forming a monolayer of the metal on the monolayer of oxygen, forming a second monolayer of oxygen, the second monolayer of oxygen being on the monolayer of the metal, and forming a monolayer of silicon on the second monolayer of oxygen. In some embodiments, the method includes using atomic layer deposition.

In some embodiments, the oxide is formed at a temperature of at least about 225 degrees Celsius (e.g., at least about 250 degrees Celsius, at least about 300 degrees Celsius).

Embodiments can have one or more of the following advantages.

In some embodiments, a layer of material containing titanium, silicon, and oxygen can be substantially amorphous and have a thickness in excess of about 50 nm. This can be desirable because, in general, amorphous materials may transmit EM radiation better than layers that are partially or mostly crystalline materials. In some embodiments, a substantially amorphous material containing silicon, titanium, and oxygen can be prepared at a temperature in excess of 190° C. For example, in some embodiments a substantially amorphous material containing silicon, titanium, and oxygen can be deposited at a temperature from about 250° C. to about 300° C. This can be advantageous because growing materials at higher temperatures can increase atom packing density, index of refraction and/or make the films more resistant to degradation from environmental changes. In addition high temperature deposition can reduce the stress in the deposited material.

In certain embodiments, an optical article can have an index of refraction that varies as a function of distance from a substrate, referred to as a graded index of refraction. The graded index of refraction can be formed, for example, by varying a ratio of titanium to silicon in a material containing silicon, titanium, and oxygen. This can be desirable because a gradual change in the index of refraction can be useful in various optical articles such as rugate filters.

In some embodiments, the optical properties such as the refractive index, mechanical integrity and/or crystallinity of an optical article can be manipulated or controlled by using one or more silicon oxide materials in which a metal (e.g., titanium) is also present. This can allow for materials to be formed in a predictable fashion that have a desired refractive index and/or other desirable properties.

Other features and advantages of the invention will be apparent from the description and drawings, and from the claims.

### DESCRIPTION OF DRAWINGS

FIG. 1A is a schematic representation of an optical filter.

FIG. 1B is a schematic representation of a rugate filter.

FIG. 2A is a schematic representation of a material layer.

FIG. 2B is a schematic representation of a material layer.

FIG. 3 is a graph of a refractive index of certain materials.

FIG. 4 is a schematic representation of an atomic layer deposition system.

FIG. 5 is a diagram of an atomic layer deposition process.

FIG. 6A is a schematic representation of a material layer.

FIG. 6B is a schematic representation of a material layer.

FIG. 7A is a schematic representation of an optical article.

FIG. 7B is a graph of the variation in atomic percentage of titanium substituted by silicon as a function of distance from a substrate.

FIG. 7C is a graph of the variation in atomic percentage of titanium substituted by silicon as a function of distance from a substrate.

FIG. 8 is a schematic representation of a multi-layer stack of materials.

FIG. 9 is a schematic representation of a Fresnel lens including a material layer.

FIG. 10 is a schematic representation of an optical system.

FIG. 11 is a schematic representation of an optical system.

FIG. 12 is a schematic representation of an optical system.

FIG. 13 is a schematic representation of an optical system.

FIG. 14 is a graph of a K refractive index (the imaginary part of the refractive index that represents the absorption in the material) for a material layer as a function of wavelength of incident EM radiation.

FIG. 15 is a graph of a refractive index for a material layer as a function of wavelength of incident EM radiation.

FIG. 16 is a graph of a refractive index for a material layer as a function of wavelength of incident EM radiation.

Like reference symbols in the various drawings indicate like elements.

### DETAILED DESCRIPTION

The disclosure generally relates to materials used to form articles that are sensitive to and can be used to control properties of EM radiation, such as the polarization and/or direction of beams incident on the articles. Examples of EM radiation include the visible region, the ultraviolet region, the infrared region, and the microwave region. In some embodiments, the articles can be sensitive to and/or can be used to control the properties of incident radiation in more than one region of the EM spectrum.

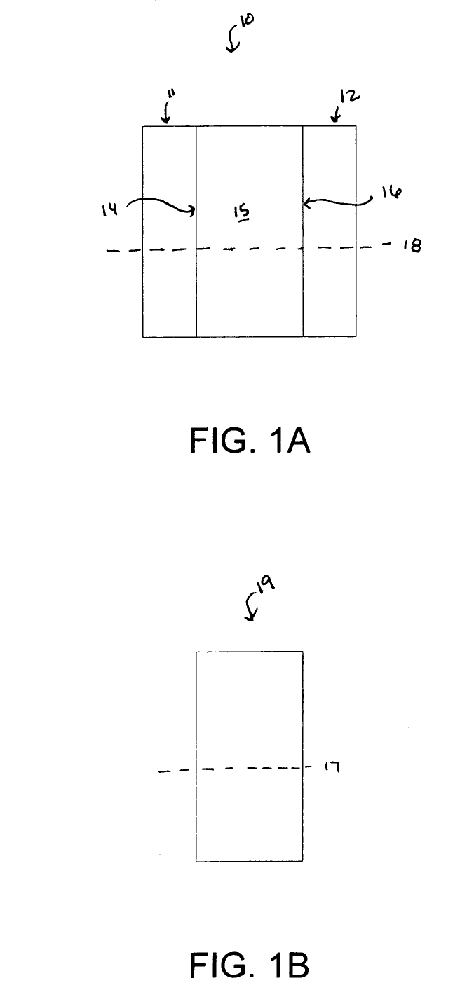

Referring to FIG. 1A, an example of an optical article is an optical filter 10. Optical filter 10 is composed of two multilayer stacks 11 and 12, disposed on opposite surfaces 14 and 16 of a substrate 15 (e.g., a glass optical flat). Optical filter 10 substantially reflects EM radiation of certain wavelengths impinging on filter 10 and propagating along an axis 18, and substantially transmits EM radiation of other wavelengths impinging on filter 10 and propagating along axis 18. Optical filter 10 also reflects EM radiation of certain wavelengths impinging on filter 10 at an angle to axis 18, while transmitting EM radiation of other wavelengths impinging on filter 10 at the same angle to axis 18. Both multilayer stacks 11 and 12 include a number alternating high refractive index and low refractive index layers formed from dielectric materials.

Without wishing to be bound by theory, it is believed that having a large difference between the indices of refraction of the two materials can increase the efficiency of the filter. Examples of materials having a high refractive index include TiO2, which has a refractive index of about 2.48 at 632 nm, Ta2O5 which has a refractive index of about 2.15 at 632 nm, and HfO2 which has a refractive index of about 1.9 at 632 nm. Examples of materials having a low refractive index include SiO2 and Al2O3, which have refractive indices of about 1.45 and about 1.65 at 632 nm, respectively.

Referring to FIG. 1B, another example of an optical article is a rugate filter 19. In general, optical articles such as rugate filter 19 are formed of a material that exhibits a gradual change/modulation in the index of refraction along an axis 17 (e.g., a change from a low index of refraction to a high index of refraction or a change from a high index of refraction to a low index of refraction). Other examples of optical articles in which it is desirable to have a gradual change in the index of refraction include, articles that include an index matching interface layer between medias of different index of refraction, light waveguide structures, and diffractive structures.

In order to form various types of optical articles, it can be desirable to control the optical transmission characteristics of a material in a predictable fashion. For example, the optical transmission characteristics of a material can vary based on a number of parameters including the refractive index of the material. As described above, in some embodiments it can be desirable to form a material having a known refractive index (e.g., a high refractive index or a low refractive index). In certain embodiments, it can be desirable to form a material having a graded refractive index.

The optical transmission characteristics can vary based on whether the material is substantially amorphous. It is believed that when EM radiation passes through certain materials that are not substantially amorphous, the materials can generate scattering losses.

In order to reduce the scattering losses for such materials, it can be beneficial for the material to be substantially amorphous (e.g., about 95% amorphous or more, about 98% amorphous or more, about 99% or more amorphous).

In some embodiments, in order to reduce the scattering losses, it can be beneficial to limit the maximum size of crystalline domains present in the material. For example, the thickness of layers that crystallize can be limited such that the size of possible crystalline domains is limited. X-ray difractometry XRD can quantify existing crystalline phase.

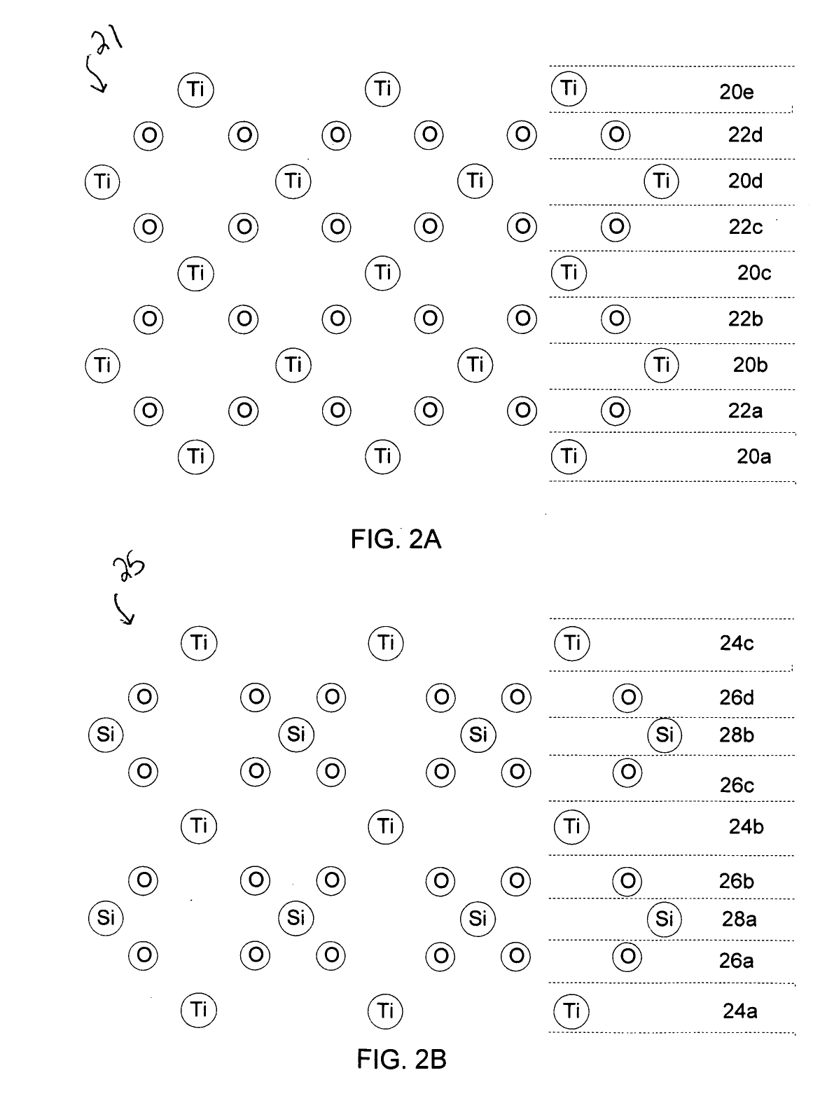

FIGS. 2A and 2B are, respectively, schematic representations of TiO2 21 and a material 25 that contains titanium, silicon, and oxygen.

Material 21 is composed of alternating layers of titanium (e.g., layers 20a, 20b, 20c, 20d, 20e) and oxygen (e.g., layers 22a, 22b, 22c, 22d). Material 21 is shown as a layer of TiO2. While material 21 is shown schematically as an ordered, crystalline layer (to aid in discussion), material 21 can exist in crystalline, substantially amorphous, or mixed form. Further, other types of titanium oxides exist. Other types of titanium oxide include, for example, Ti2O3 and Ti3O5. Titanium oxide layers often grow with tensile stress which can limit the total thickness of the titanium oxide which can be deposited. One method to reduce the tensile stress in a titanium oxide material is to grow the material at an elevated temperature (e.g., a temperature greater than about 200° C., typically 250-350° C.). While growing the titanium oxide at an elevated temperature can be beneficial in reducing stress in the material, titanium oxide layers often exhibit a phase transition from being substantially amorphous to being crystalline at a growth temperature of about 180° C. and above. In general, the amount of crystalline phase increases with temperature and/or with the total thickness of the deposited titanium oxide material. For example, titanium oxide layers having a thickness of above about 80 nm tend to show an increased presence of crystalline phase compared to thinner layers (e.g., layers with a thickness of about 20 nm or less).

It is believed that introducing at least some silicon into a titanium oxide material to form a material composed of silicon, titanium, and oxygen (such as material 25) can alter the refractive index and/or certain other characteristics (e.g., whether the material is substantially amorphous) of the material. It is believed that the refractive index and/or certain other characteristics can be altered by varying the ratio of the atomic percent of titanium to the atomic percent of silicon in the material.

In comparison to material 21, in material 25 some of the titanium atoms have been selectively substituted with silicon atoms. Specifically, relative to material 21, in material 25, fifty percent of the titanium atoms have been substituted by silicon atoms such that material 25 includes multiple layers of titanium (e.g., layers 24a, 24b, and 24c), multiple layers of silicon (e.g., layers 28a and 28b), and multiple layers of oxygen (e.g., layers 26a, 26b, 26c, 26d). It is believed that substituting at least some of the titanium with silicon during the growth of material 25 can modify the internal material stress and/or the refractive index of material 25 while maintaining low optical losses for material 25. It is also believed that substituting at least some of the titanium with silicon during the growth of material 25 can increase the temperature at which a transition of the material containing silicon, titanium, and oxygen from being substantially amorphous to crystalline occurs. Thus, it is believed that in comparison to material 21, material 25 can be deposited at higher temperatures and/or greater thicknesses while remaining substantially amorphous.

It is believed that, by selectively substituting at least some of the titanium in a titanium oxide material with silicon to form a material containing silicon, titanium, and oxygen, a substantially amorphous material (e.g., a material in which little or no crystalline or crystal grain structure exist) can be formed having a thickness of at least about 5 nm (e.g., at least about 10 nm, at least about 20 nm, at least about 40 nm, at least about 50 nm, at least about 80 nm, at least about 100 nm, at least about 120 nm, at least about 150 nm). Various methods can be used to determine if the material is substantially amorphous. For example, in some embodiments, X-Ray difraction (XRD) can identify and quantify specific material phase(s) present in the material layers. In another example, optical measurements with transmitted light can be used to determine if the material is substantially amorphous. The optical measurements will show reduced transmission due to scattering when a non-amorphous, e.g., crystalline, structure exists. The transmission can be observed with spectrophotometer or tunable laser source and detector. In an additional example, visual inspection of a wafer under oblique incidence of light (e.g., a light source with strong blue light content such as Xenon or Halogen lamp) can be used to determine if the material is substantially amorphous. If the material has a crystalline structure, the material will appear hazy or milky.

In some embodiments, such a substantially amorphous material containing silicon, titanium, and oxygen can have an index of refraction of about 1.8 or greater at a wavelength of 632 nm (e.g., about 2.0 or greater at a wavelength of 632 nm, about 2.1 or greater at a wavelength of 632 nm, about 2.2 or greater at a wavelength of 632 nm, about 2.3 or greater at a wavelength of 632 nm).

In some embodiments, a substantially amorphous material containing silicon, titanium, and oxygen can be formed at temperatures above about 190° C. (e.g., above about 200° C., above about 220° C., above about 240° C., above about 250° C., above about 260° C., above about 280° C., above about 300° C., above about 320° C.). In some embodiments, such a material can have an index of refraction of about 1.8 or greater at a wavelength of 632 nm (e.g., about 2.0 or greater at a wavelength of 632 nm, about 2.1 or greater at a wavelength of 632 nm, about 2.2 or greater at a wavelength of 632 nm, about 2.3 or greater at a wavelength of 632 nm).

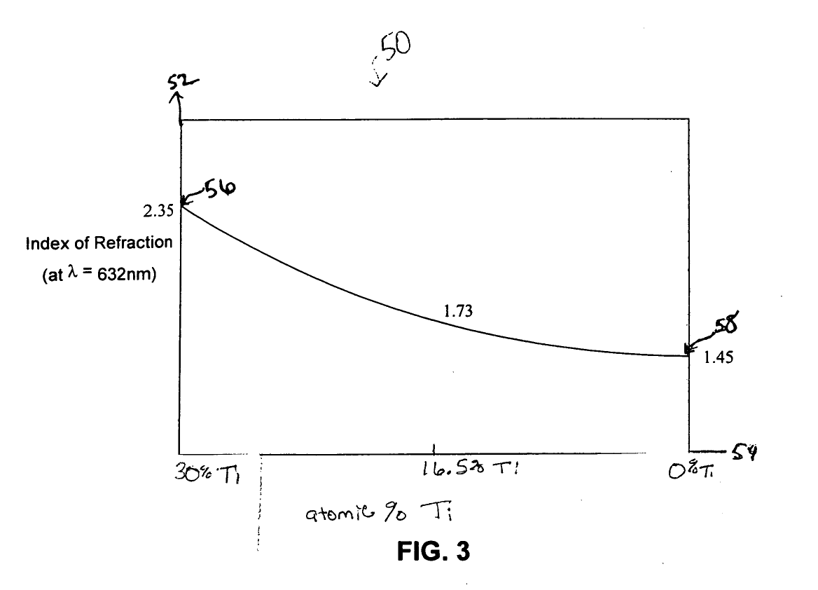

It is also believed that varying the atomic ratio of titanium to silicon in a material containing silicon, titanium, and oxygen can modify the refractive index of the resulting material. FIG. 3 shows a graph 50 of the estimated index of refraction of a material containing silicon, titanium, and oxygen as a function of the atomic percentage of titanium in the material. In graph 50, the y-axis represents the estimated refractive index and the x-axis represents the atomic percent of titanium in the material. As the atomic percent of titanium decreases, the atomic percent of silicon increases. Thus, when x equals 30% the material is 30% titanium and 3% silicon, when x equals 16.5%, the material is TiSiO4, and when x equals 0% the material is SiO2.

In general, the refractive index of the material containing silicon, titanium, and oxygen decreases as the proportion of silicon in the material increases. The index of refraction is bounded by the index of refraction of TiO2 (as indicated by arrow 56) and the index of refraction of SiO2 (as indicated by arrow 58). Thus, for a material containing titanium, silicon and oxygen, the index of refraction varies from about 2.45 to about 1.45 as measured using a wavelength of 632 nm. SiO2 has a lower refractive index than TiO2, therefore, the greater the ratio of silicon atoms to titanium atoms the lower the index of refraction of the material containing titanium, silicon and oxygen will be. Thus, the refractive index of the material containing titanium, silicon and oxygen can be controlled by modifying a proportion of silicon relative to titanium in the material containing titanium, silicon and oxygen.

In some embodiments, the material containing silicon, titanium, and oxygen can include at least about 1 atomic percent silicon (e.g., at least about 2 atomic percent silicon, at least about 5 atomic percent silicon, at least about 10 atomic percent silicon, at least about 15 atomic percent silicon) and/or at most about 20 atomic percent silicon (e.g., at most about 15 atomic percent silicon, at most about 10 atomic percent silicon, at most about 5 atomic percent silicon). For example, in certain embodiments, the material containing silicon, titanium, and oxygen can include from about 1 atomic percent to about 10 atomic percent silicon (e.g., from about 1 atomic percent to about 5 atomic percent silicon, from about 1 atomic percent to about 3 atomic percent silicon, from about 1 atomic percent to about 2 atomic percent silicon).

In some embodiments, the material containing silicon, titanium, and oxygen can include at least about 15 atomic percent titanium (e.g., at least about 20 atomic percent titanium, at least about 25 atomic percent titanium, at least about 30 atomic percent titanium) and/or at most about 32 atomic percent titanium (e.g., at most about 30 atomic percent titanium, at most about 25 atomic percent titanium, at most about 20 atomic percent titanium). In certain embodiments, the material containing silicon, titanium, and oxygen can include from about 25 atomic percent to about 32 atomic percent titanium (e.g., from about 28 atomic percent to about 32 atomic percent titanium, from about 30 atomic percent to about 32 atomic percent titanium).

In some embodiments, the ratio of the atomic percentage of titanium to the atomic percentage of silicon in a material containing titanium, silicon, and oxygen can be at least about 1.0 (e.g., at least about 2, at least about 5, at least about 7, at least about 9, at least about 12, at least about 15) and/or at most about 200 (e.g., at most about 150, at most about 100, at most about 50). In some embodiments, in a material containing silicon, titanium, and oxygen having a ratio of the atomic percent of titanium to the atomic percent of silicon greater than 1, the material can have a refractive index of at least about 1.8 at a wavelength of 632 nm (e.g., at least about 1.9 at a wavelength of 632 nm, at least about 2.0 at a wavelength of 632 nm, at least about 2.1 at a wavelength of 632 nm, at least about 2.2 at a wavelength of 632 nm, at least about 2.3 at a wavelength of 632 nm, at least about 2.4 at a wavelength of 632 nm).

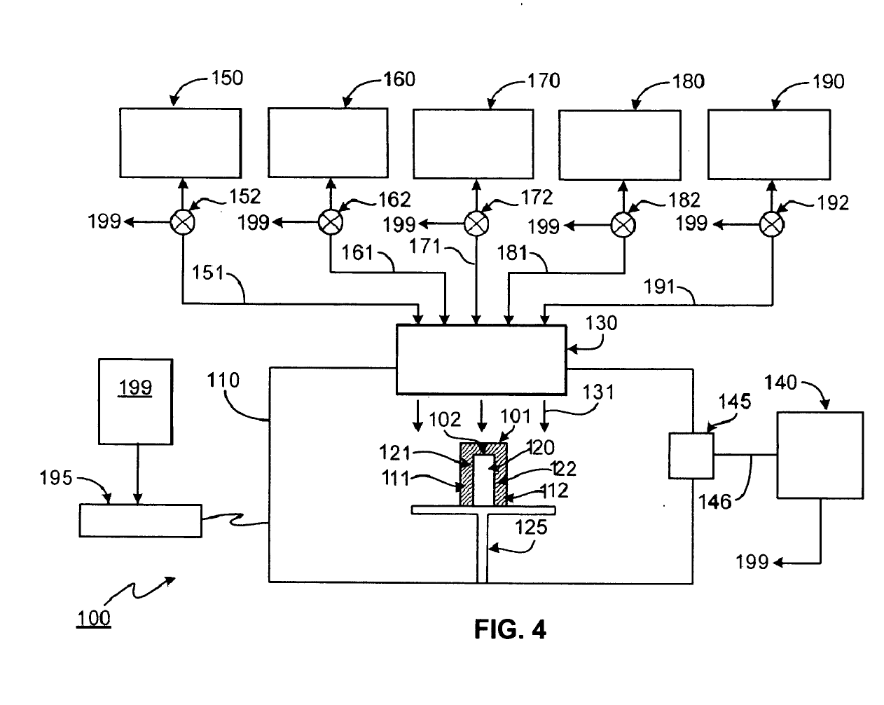

In general, a material containing silicon, titanium, and oxygen can be prepared as desired. In some embodiments, a material containing silicon, titanium, and oxygen can be prepared using atomic layer deposition (ALD). Referring to FIG. 4, an ALD system 100 is used to deposit layers 111 and 112 on surfaces 121 and 122, respectively, of substrate 120. An additional multilayer material 101 is deposited on exposed surface 102. Without wishing to be bound by theory, it is believed that the deposition of multilayer stacks 111, 112, and 101 occurs monolayer by monolayer, providing substantial control over the composition and thickness of the material. During deposition of a monolayer, vapors of a precursor are introduced into the chamber 110 and are adsorbed onto substrate surfaces 111, 112, and 102 or onto previously deposited layers supported by these surfaces. Subsequently, a reactant is introduced into the chamber that reacts chemically with the adsorbed precursor, forming a layer of a desired material. The self-limiting nature of the chemical reaction on the surface can provide control of material thickness and composition of the deposited material. Moreover, the non-directional adsorption of precursor onto exposed surfaces provides for an approximately uniform deposition of material onto surfaces having different orientations relative to chamber 110.

ALD system 100 includes a reaction chamber 110, which is connected to sources 150, 160, 170, 180, and 190 via a manifold 130. Sources 150, 160, 170, 180, and 190 are connected to manifold 130 via supply lines 151, 161, 171, 181, and 191, respectively. Valves 152, 162, 172, 182, and 192 regulate the flow of gases from sources 150, 160, 170, 180, and 190, respectively. Sources 150 and 180 contain a first and second precursor, respectively, while sources 160 and 190 include a first reagent and second reagent, respectively. For example, if a material containing titanium, silicon and oxygen is being deposited, sources 150 and 180 can contain titanium and silicon precursors while sources 160 and 190 can contain an oxygen providing reagent. Source 170 contains a carrier gas, which is flowed through chamber 110 during the deposition process transporting precursors and reagents to substrate 120, while transporting reaction byproducts away from the substrate. Precursors and reagents are introduced into chamber 110 by mixing with the carrier gas in manifold 130. Gases are exhausted from chamber 110 via an exit port 145. A pump 140 exhausts gases from chamber 110 via an exit port 145. Pump 140 is connected to exit port 145 via a tube 146.

ALD system 100 includes a temperature controller 195, which controls the temperature of chamber 110. During deposition, temperature controller 195 elevates the temperature of substrate 120 and multilayer material 101 deposited on substrate 120 above room temperature. In general, the substrate temperature should be sufficiently high to facilitate a rapid reaction between precursors and reagents, but should not cause precursor pre-decomposition nor damage the substrate. In some embodiments, the substrate temperature can be about 500° C. or less (e.g., about 400° C. or less, about 300° C. or less, about 200° C. or less, about 150° C. or less, about 125° C. or less). In some embodiments, the substrate temperature can be about 150° C. or greater (e.g., about 180° C. or greater, about 200° C. or greater, about 250° C. or greater, about 300° C. or greater).

Deposition process parameters are controlled and synchronized by an electronic controller 199. Electronic controller 199 is in communication with temperature controller 195; pump 140; and valves 152, 162, 172, 182, and 192. Electronic controller 199 also includes a user interface, from which an operator can set deposition process parameters, monitor the deposition process, and otherwise interact with system 100.

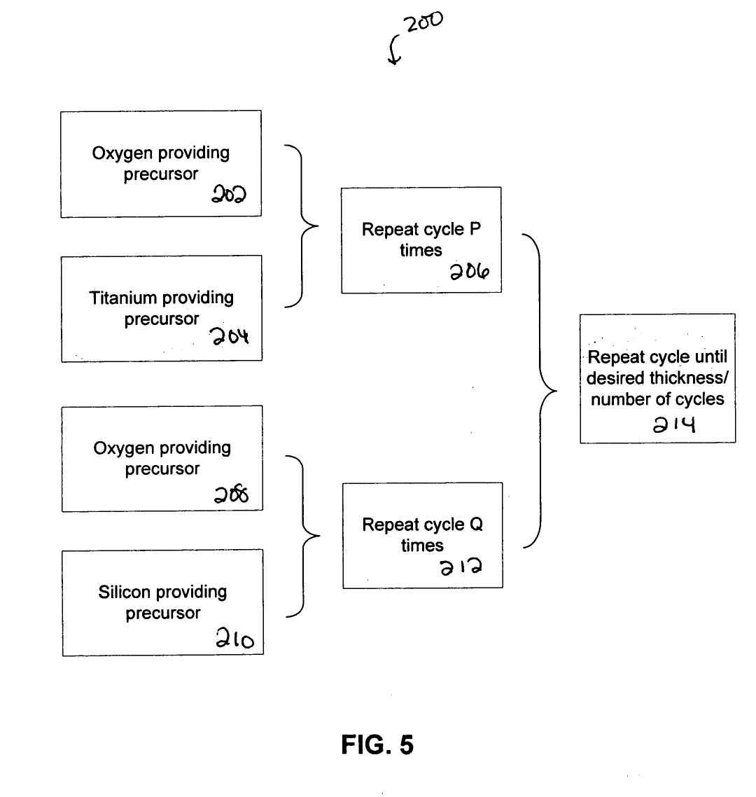

FIG. 5 shows an ALD process 200 for generating a material containing silicon, titanium, and oxygen using ALD system 100. In general, process 200 involves delivery of oxygen providing precursor (e.g., H2O), a titanium providing precursor, and a silicon providing precursor to form monolayers of oxygen, titanium, and silicon, respectively. Process 200 begins when system 100 introduces an oxygen providing precursor (sometimes referred to as a reagent) into chamber 110 (202). Examples of oxygen providing precursors (sometimes referred to as reagents) include water, O atomic oxygen in plasma, O2 oxygen, O3 ozone and alcohols. The introduction of the oxygen providing precursor forms a monolayer of oxygen onto surfaces 121, 122, and 102 of substrate 120. The residual precursor is purged from chamber 1 10 by the continuous flow of a carrier gas through the chamber. Subsequently, the system introduces a titanium providing precursor into chamber 110 (204). Examples of titanium precursors include titanium halides, titanium alkoxides, titanium amides, titanium acetamidinates, organometallic titanium compounds. Examples of Titanium halides include Titanium (IV) chloride (TiCl4), Titanium (IV) bromide (TiBr4), and Titanium (IV) iodide (TiI4). Examples of Titanium alkoxides include Titanium (IV) ethoxide (Ti[OC2H5]4), Titanium (IV) i-propoxide (Ti[OCH(CH3)2]4), and Titanium (IV) t-butoxide (Ti[OC4H9]4). Examples of Titanium amides include Tetrakis(dimethylamino)titanium (Ti[N(CH3)2]4), Tetrakis(diethylamino)titanium (Ti[N(C2H5)2]4), and Tetrakis(ethylmethylamino)titanium (Ti[N(C2H5)(CH3)]4). The titanium providing precursor reacts with the monolayer of chemisorbed oxygen providing reactant to form a monolayer of titanium on the monolayer of oxygen. The residual precursor is purged from chamber 110 by the continuous flow of the carrier gas through the chamber 110.

The introduction of the oxygen providing precursor (202) followed by the titanium providing precursor (204) is repeated for a predetermined number of cycles, P (206). This forms a layer of titanium oxide (e.g., composed of alternating layers of titanium and oxygen) on the surface of substrate 120.

After the predetermined number of cycles, P, system 100 introduces an oxygen providing precursor (208). The introduction of the oxygen providing precursor forms a monolayer of chemisorbed oxygen providing reactant on the surface of the most recently deposited titanium monolayer. The residual precursor is purged from chamber 110 by the continuous flow of carrier gas through the chamber. Subsequently, the system introduces a silicon providing precursor into chamber 110 (210). Examples of silicon providing precursors include tetrabutoxysilane, tres(tertpentory)sil and, silicon halides (SiCl4), terasiso-cyanatosilane, tetrakis(dimethylamids)silane, and tris(dimethlamido)silane. The silicon providing precursor reacts with the monolayer of chemisorbed oxygen providing reactant to form a monolayer of silicon on the layer of oxygen. The residual precursor is purged from chamber 110 by the continuous flow of carrier gas through the chamber. The introduction of the oxygen providing precursor (208) followed by the silicon providing precursor (210) is repeated for a predetermined number of cycles, Q (212).

The process of repeating the titanium cycle P times (206) followed by repeating the silicon cycle Q times (212) is repeated R times (214) to form a bulk layer of a material containing titanium, silicon and oxygen having a desired thickness. As described above, the index of refraction of the bulk layer of a material containing titanium, silicon and oxygen will be greater than the index of refraction of bulk SiO2 and less than the index of refraction of bulk TiO2. The index of refraction of the material containing silicon, titanium, and oxygen is related to the ratio of P to Q. For example, as the ratio of P to Q increases the refractive index of the deposited material containing titanium, silicon and oxygen increases and as the ratio of P to Q decreases the refractive index of the material containing titanium, silicon and oxygen decreases.

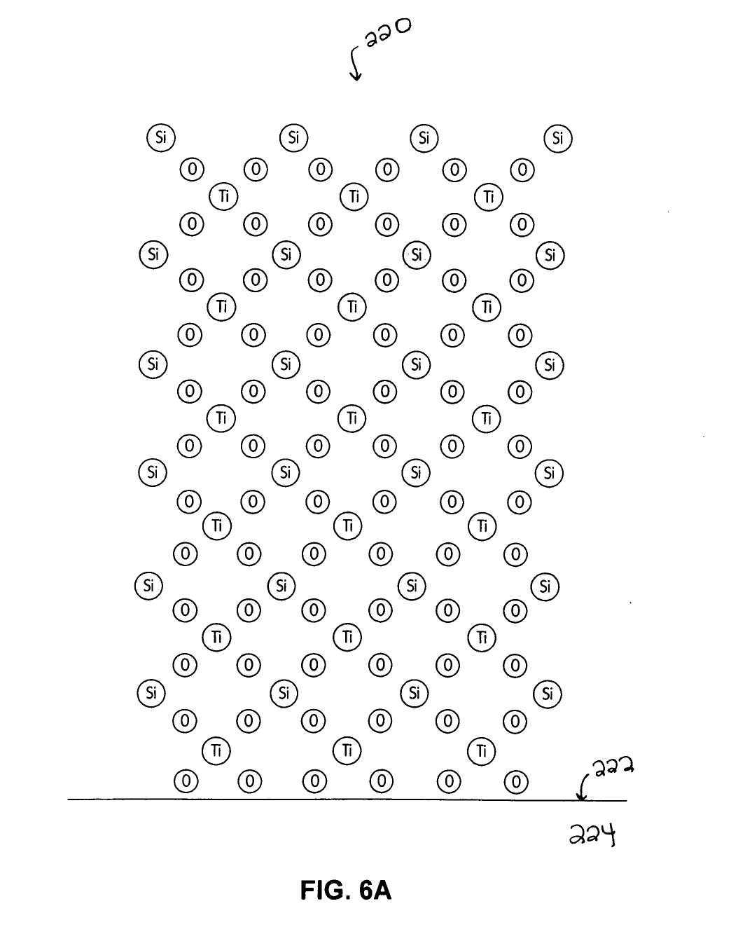

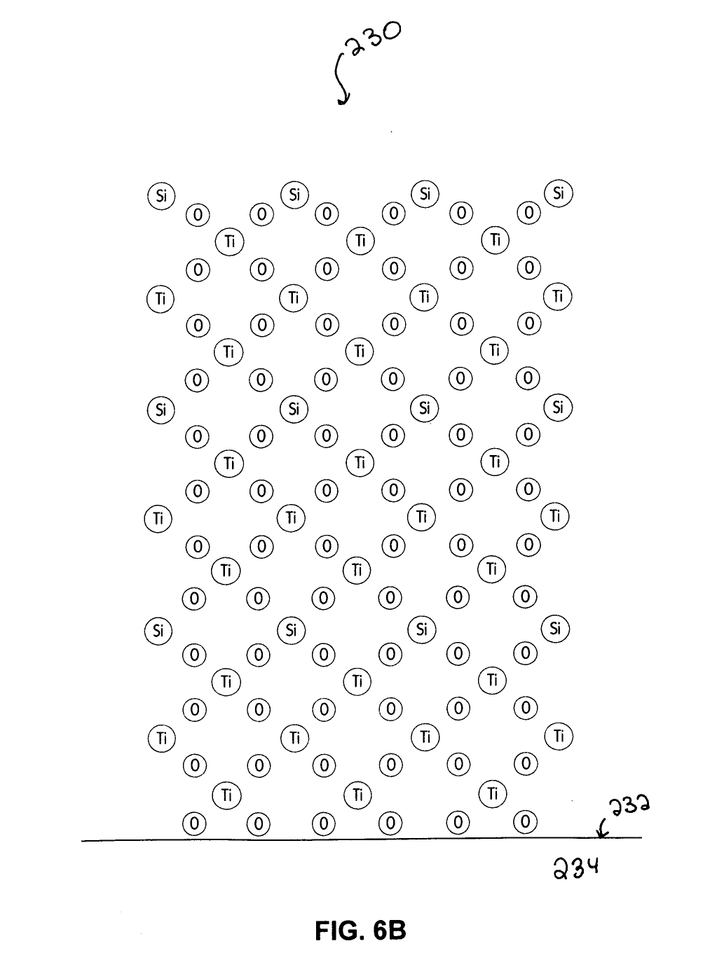

FIG. 6A shows an example of a bulk layer of a material containing titanium, silicon and oxygen 220 formed on a surface 222 of a substrate 224. Layer 220 is formed using process 200 (FIG. 5) where P=1, Q=1, and R=6. When P=1 and Q=1, fifty percent of the titanium that would be present in a titanium oxide material is substituted with silicon. Values of P=1, Q=1, and R=6 would indicate a repetition of following sequence six times: oxygen precursor+titanium. precursor+oxygen precursor+silicon precursor. In general, a ratio of P to Q of I (e.g., P=1 and Q=1, P=2 and Q=2, P=3 and Q=3, P=4 and Q=4) results in a material is comprised of about 66 atomic percent oxygen, about 16.5 atomic percent titanium, and about 16.5 atomic percent silicon.

FIG. 6B shows and example of a bulk layer of a material containing titanium, silicon and oxygen 230 formed on a surface 232 of a substrate 234 using process 200 where P=3, Q=1, and R=3. When P=3 and Q=1, twenty-five percent of the titanium that would be present in a pure titanium oxide material is substituted with silicon. Values of P=3, Q=1, and R=3 would indicate a repetition of following sequence three times: oxygen precursor+titanium precursor+oxygen precursor+titanium precursor+oxygen precursor+titanium precursor+oxygen precursor+silicon precursor. Thus, if P=3 and Q=1 every fourth non-oxygen cycle is a silicon cycle. In general, a ratio of P to Q of 3 (e.g., P=3 and Q=1, P=6 and Q=2, P=9 and Q=3, P=12 and Q=4) results in a material comprised of about 66 atomic percent oxygen, about 24 atomic percent titanium, and about 8 atomic percent silicon.

In some embodiments, it is desirable to grow a bulk material containing silicon, titanium, and oxygen having a relatively high index of refraction. In order to grow a material containing silicon, titanium, and oxygen with a high index of refraction, typically less than 50% of the titanium atoms will be substituted with silicon atoms such that P will be greater than Q. For example, a ratio of P to Q can be at least about 2 (e.g., at least about 3, at least about 4, at least about 5, at least about 10, at least about 20, at least about 40). For example, in some embodiments, a ratio of P to Q can be 120:6, 140:6, 200:6, or 240:6.

Although the oxygen-providing precursor is introduced into the chamber before the silicon or titanium providing precursor during each cycle in process 200 described above, in other examples the oxygen-providing precursor can be introduced after the silicon or titanium providing precursor. The order in which the oxygen-providing precursor and the silicon or titanium providing precursor are introduced can be selected based on their interactions with the exposed surfaces. For example, where the bonding energy between the titanium or silicon precursor and the surface of the substrate on which the material is grown is higher than the bonding energy between the oxygen providing precursor and the surface, the silicon or titanium providing precursor can be introduced before the oxygen providing precursor. Alternatively, if the binding energy of the oxygen providing precursor is higher, the oxygen providing precursor can be introduced before the silicon or titanium providing precursor. While process 200 described above includes introducing an oxygen providing precursor followed by a silicon providing precursor to deposit a monolayer of oxygen and a monolayer of silicon, other methods for depositing low index materials based on metal-silicates. For example, a precursor that includes both oxygen and silicon can be used to selectively deposit monolayer of oxygen and a monolayer of silicon upon the introduction of a single precursor. Examples of such precursors include tris(tert-butoxy)silanol ((tBuO)3SiOH), or tris(tert-pentoxy)silanol, or tris(isopropxy)silanol, or bis(tert-butoxy)(isopropoxy)silanol, or bis(isopropoxy)(tert-butoxy)silanol, or bis(tert-pentoxy)(isopropoxy)silanol bis(isopropoxy)(tert-pentoxy)silanol, or bis(tert-pentoxy)(tert-butoxy)silanol bis(tert-butoxy)(tert-pentoxy)silanol. Examples of such silicon precursors and their use are described, for example, in U.S. Pat. No. 6,969,539.

In some embodiments, when precursors such as tris(tert-butoxy)silanol are used, the introduction of the tris(tert-butoxy)silanol is preceded by the introduction of the metal providing precursor. The metal-providing precursor acts as a catalyst for the Silanol to attach a Si and O atoms using a single precursor. For example, a process can include introducing a TMA pulse which deposits Al-2(CH)3 on a surface of a wafer. Subsequent to the TMA pulse, silanol is introduced. The Silanol removes the two CH3 molecules by converting them to CH4 and Si and O are attached. A similar reaction can be performed using TiCl4 is used instead of TMA.

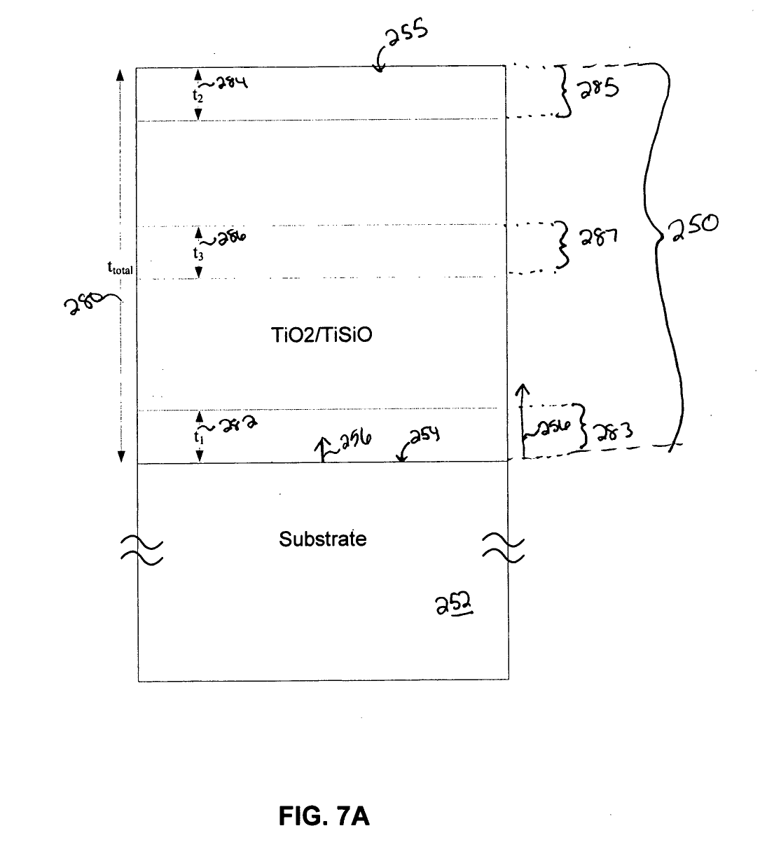

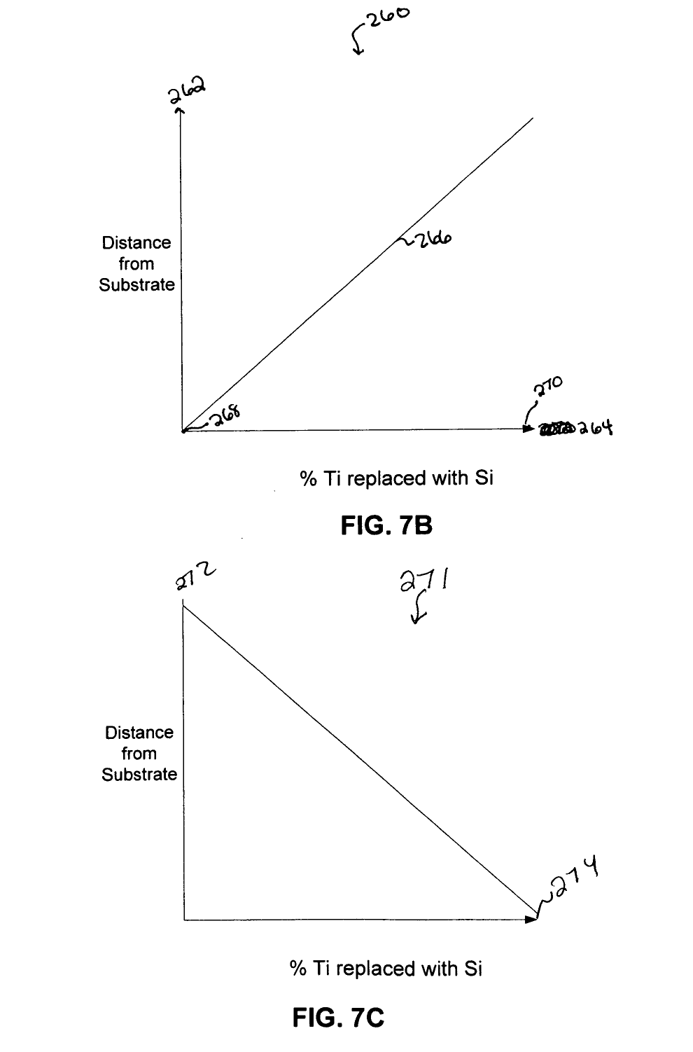

While embodiments described above show a bulk material comprised of silicon, titanium, and oxygen with a constant composition throughout the material, in some embodiments it can be beneficial to form a material having a composition that varies. FIG. 7A shows a material 250 that has an index of refraction that varies at different locations within the material. For example, material 250 can have an index of refraction that is graded as a function of a distance from a surface 254 of a substrate 252 (e.g., in a direction substantially perpendicular to surface 254 as indicated by arrow 256). Material 250 can be formed by selective substitution of titanium atoms with silicon atoms during the growth of the material (as compared to the growth of titanium oxide). In general, to form a material with a graded index of refraction, the ratio of titanium to silicon for a given thickness of material varies as a function of distance from surface 254.

When material 250 is formed, different portions of material 250 have different chemical compositions and therefore, different indices of refraction. For example, material 250 can have a total thickness defined by surface 254 of substrate 252 and a surface 255 of material 250 (as indicated by arrow 280). The material can be formed such that different portions of material 250 have different atomic percentages of silicon and titanium. A first portion 283 of material 250 can be at least partially defined by surface 254 of substrate 252 and have a thickness, t1 (as indicated by arrow 282). A second portion 285 of material 250 can be at least partially defined by surface 255 of layer 250 and can have a thickness, t2, (as indicated by arrow 284). A third portion 287 of material 250 can be disposed between first portion 283 and second portion 285 and have a thickness t3 (as indicated by arrow 286).

In order to form a material having a graded index of refraction, the average atomic percentage of silicon of portion 283, portion 285, and portion 287 will be different In material layers for which the index of refraction decreases as a function of the distance from surface 254 of substrate 252, the average atomic percentage of silicon of portion 283 will be greater than the average atomic percentage of silicon of portion 285 and the average atomic percentage of silicon in portion 287 will be less than the average atomic percentage of silicon in portion 285 and greater than the average atomic percentage of silicon in portion 283. In material layers for which the index of refraction increases as a function of the distance from the surface of substrate 252, the average atomic percentage of silicon of portion 283 will be lower than the average atomic percentage of silicon of portion 285 and the average atomic percentage of silicon in portion 287 will be greater than the average atomic percentage of silicon in portion 285 and less than the average atomic percentage of silicon in portion 283.

The difference in the average atomic percentage of silicon of portion 283 compared to the average atomic percentage of silicon of portion 285 can be at least about one percentage (e.g., at least about 5 percentage, at least about 10 percentage, at least about 20 percentage, at least about 30 percentage, at least about 40 percentage, at least about 50 percentage, at least about 60 percentage, at least about 70 percentage, at least about 80 percentage, at least about 90 percentage, at least about 95 percentage). The atomic percentage of silicon in layer 287 will be between the atomic percentage of silicon in layer 283 and atomic percentage of silicon in layer 285. The average atomic percent silicon for the portion having the lesser atomic percentage of silicon (e.g., portion 283 if the refractive index increases) as a function of the distance from surface 254 of substrate 252 or portion 285 if the refractive index increases as a function of the distance from surface 254 of substrate 252) can be at least about 1 atomic percent of (e.g., at least about 3 atomic percent, at least about 5 atomic percent, at least about 10 atomic percent) silicon and/or at most about 20 atomic percent (e.g., at most about 15 atomic percent, at most about 10 atomic percent) silicon. For example, the average atomic percentage of the portion having the lesser atomic percentage of silicon can have an atomic percent from about 1 atomic percent to about 20 atomic percent (e.g., from about 1 atomic percent to about 10 atomic percent, from about 1 atomic percent to about 5 atomic percent, from about 5 atomic percent to about 10 atomic percent).

The average atomic percent silicon of the portion having the greater atomic percentage of silicon (e.g., portion 283 if the refractive index increases as a function of the distance from surface 254 of substrate 252 or portion 285 if the refractive index decreases as a function of the distance from surface 254 of substrate 252) can be at least about 10 atomic percent (e.g., at least about 15 atomic percent, at least about 20 atomic percent, at least about 25 atomic percent) silicon, and/or at most about 30 atomic percent (e.g., at most about 25 atomic percent, at most about 20 atomic percent) silicon. For example, the average atomic percent silicon of the portion having the greater atomic percentage of silicon be from about 10 atomic percent to about 30 percent (e.g., from about 10 atomic percent to about 30 atomic percent, from about 20 atomic percent to about 30 atomic percent, from about t25 atomic percent to about 30 atomic percent).

In some embodiments it can be beneficial to form a material having an index of refraction that varies according to an approximately periodic function. For example, in some embodiments the material can have an index of refraction that varies according to a function with a constant period (e.g., a sine or cosine function). For example, starting from the substrate, the index of refraction can increase until it reaches maximum and then decrease until the index of refraction reaches the initial index value. The index of refraction in the material continues to decrease until it reaches its lowest value and then increases until it reaches the start value. The total optical design of the material will include multiple periods as described above. In another example, starting from the substrate, the index of refraction can decrease until it reaches a minimum and then increase until the index of refraction reaches the initial index value. The index of refraction in the material continues to increase until it reaches its highest value and then decreases until it reaches the start value. The total optical design of the material will include multiple periods as described above. In some embodiments, the index of refraction can vary between a maximum of about 1.48 and a minimum of about 2.44.

In some additional embodiments, the material composition can vary to form a material having an index of refraction that varies according to a function with a varying period (e.g., a chirped function).

In some embodiments, the percentage of the titanium atoms substituted with silicon atoms during the growth of the material can increase as the distance from substrate 252 increases. FIG. 7B shows an exemplary graph 260 in which the percentage of titanium atoms substituted with silicon atoms (as shown on the x-axis) increases as a function of the distance from surface 254 of substrate 252 (as shown on the y-axis). In this example, the index of refraction decreases as the distance from surface 254 of substrate 252 increases. A material having a decreasing index of refraction can be formed by decreasing the ratio of P (e.g., the number of titanium cycles as described in FIG. 5) to Q (e.g., the number of silicon cycles as described in FIG. 5) during the deposition of the material. By decreasing the ratio of P to Q, the atomic percentage of silicon in a given thickness of the material increases as a function of the distance from surface 254 of substrate 252.

In some embodiments, the percentage of the titanium atoms substituted with silicon atoms decreases as the distance from substrate 252 increases. FIG. 7C shows an exemplary graph 271 in which the percentage of titanium atoms substituted with silicon atoms (as shown on the x-axis) decreases as a function of the distance from the substrate surface 254 (as shown on the y-axis). In this example, the index of refraction increases as the distance from surface 254 of substrate 252 increases. A material having a increasing index of refraction can be formed by increasing the ratio of P (e.g., the number of titanium cycles as described in FIG. 5) to Q (e.g., the number of silicon cycles as described in FIG. 5) during the deposition of a material layer. By increasing the ratio of P to Q, the atomic percentage of silicon in a given thickness of the material decreases as a function of the distance from surface 254 of substrate 252.

While in the examples described above in relation to FIGS. 7B and 7C, the material was graded from TiO2 to SiO2 or vice versa, the amount of titanium substituted by silicon need not vary by 100 percent. For example, the amount of titanium substituted by silicon can vary by from about 1 percent to about 100 percentage (e.g., about 5 percentage, about 10 percentage, about 20 percentage, about 30 percentage, about 40 percentage, about 50 percentage, about 60 percentage, about 70 percentage, about 80 percentage, about 90 percentage).

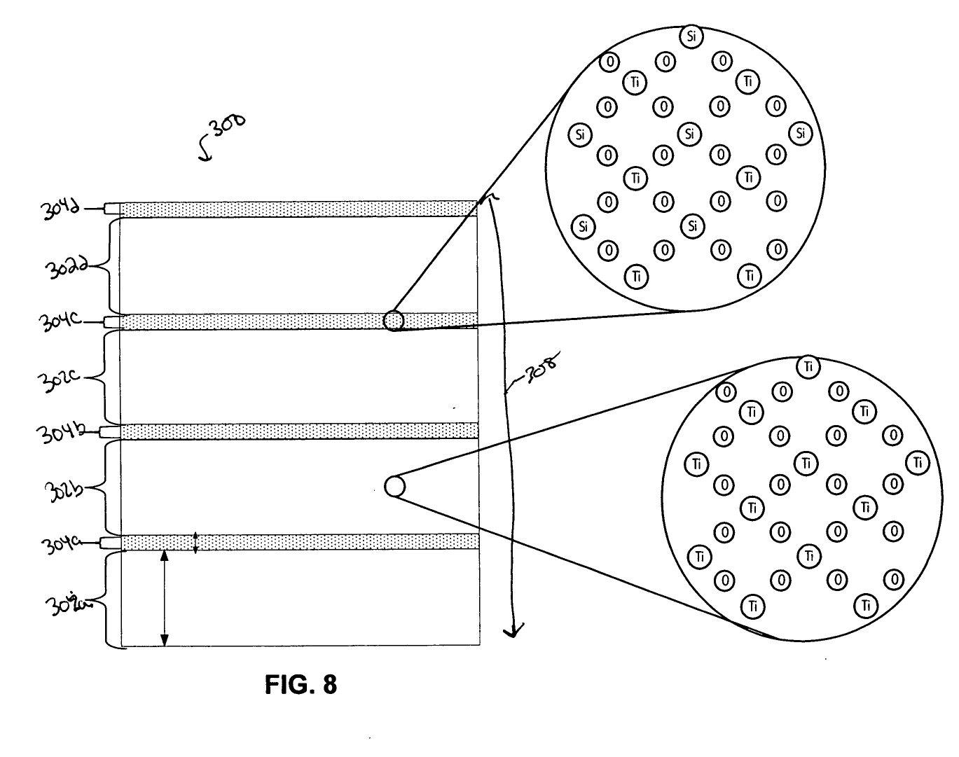

While embodiments described above relate to a bulk layer of material that includes titanium, silicon and oxygen, in some embodiments a multi-layer stack of materials can include alternating layers of different materials. For example, FIG. 8 shows a multi-layer stack 300 which includes multiple layers of material with different refractive indices. Multi-layer stack 300 includes alternating layers of titanium oxide (e.g., layers 302a, 302b, 302c, and 302d) and layers of material containing titanium, silicon and oxygen (e.g., layers 304a, 304b, 304c, and 304d). It is believed that the introduction of layers of material containing titanium, silicon and oxygen (e.g., layers 304a, 304b, 304c, and 304d) between layers of titanium oxide (e.g., layers 302a, 302b, 302c, and 302d) can inhibit the tendency of the titanium oxide to crystallize.

The thickness of the titanium oxide layers 302a, 302b, 302c, and 302d and the layers of material containing titanium, silicon and oxygen 304a, 304b, 304c, and 304d can be selected as desired. The thickness of the titanium oxide layers 302a, 302b, 302c, and 302d can be at least about 5 nm (e.g., at least about 8 nm, at least about 10 nm, at least about 12 nm, at least about 15 nm, at least about 20 nm). The maximum thickness of the titanium oxide layers 302a, 302b, 302c, and 302d can also be selected as desired. For example, the maximum thickness of the titanium oxide layers 302a, 302b, 302c, and 302d can be selected to limit the absorption or scattering loss for the material and/or to maintain an amorphous material. In some embodiments, the thickness of the titanium oxide layers 302a, 302b, 302c, and 302d can be at most about 30 nm (e.g., at most about 25 nm, at most about 20 nm, at most about 15 nm).

In general, the thickness of layers of material containing titanium, silicon and oxygen 304a, 304b, 304c, and 304d can be selected as desired. In some embodiments, the thickness of the layers of material containing titanium, silicon and oxygen 304a, 304b, 304c, and 304d can be less than the thickness of the titanium oxide layers 302a, 302b, 302c, and 302d. It is believed that if the thickness of the layers of material containing titanium, silicon and oxygen 304a, 304b, 304c, and 304d is significantly smaller than the wavelength of visible light (e.g., less than about 400 nm) the light “sees” an effective index of refraction that characterizes the total material with one bulk value for the index of refraction. The thickness of the layers of material containing titanium, silicon and oxygen 304a, 304b, 304c, and 304d can also be selected to inhibit or reduce the tendency of the titanium oxide layers to crystallize.

The thickness of the layers of material containing titanium, silicon and oxygen 304a, 304b, 304c, and 304d can be at least about 0.2 nm (e.g., at least about 0.5 nm, at least about 0.75 nm, at least about 1 nm, at least about 1.5 nm, at least about 1.75 nm, at least about 2 nm, at least about 2.5 nm) and/or at most about 3 nm (e.g., at most about 2.5 nm, at most about 1.5 nm, at most about 1.0 nm, at most about 0.75 nm). In some embodiments, the thickness of the layers of material containing titanium, silicon and oxygen 304a, 304b, 304c, and 304d can be from about 0.2 nm to about 3 nm (e.g., from about 0.2 nm to about 2 nm, from about 0.2 nm to about 1.5 nm, from about 0.2 nm to about 1 nm, from about 0.2 nm to about 0.75 nm, from about 0.2 nm to about 0.5 nm).

The percentage of the total thickness of the material (as indicated by arrow 308) comprised of the material containing titanium, silicon and oxygen (e.g., a sum of the thicknesses of layers 304a, 304b, 304c, and 304d divided by the total thickness of the material) can be selected as desired. In some embodiments, the percentage of the total thickness of the material composed of material containing titanium, silicon and oxygen can be from about 2 percent to about 10 percent (e.g., from about 2 percent to about 8 percent, from about 2 percent to about 5 percent, about 2 percent, about 3 percent, about 4 percent, about 5 percent). In general, by varying the ratio of titanium oxide material to the material containing silicon, titanium, and oxygen the index of refraction can be modified to meet optical design requirements (e.g., to obtain a particular refractive index).

In some embodiments, it is believed that layers 304a, 304b, 304c, and 304d can exhibit compressive stress while titanium oxide layers 302a, 302b, 302c, and 302d can be exhibit tensile stress. In general, titanium oxide layers tend to grow with tensile stress. Layers 304a, 304b, 304c, and 304d exhibit different properties than the titanium oxide layers due to the substitution of some Titanium atoms with Silicon atoms (e.g., when grown under some conditions the TiSiO material may exhibit compressive strain). It is believed that the introduction of several (e.g., about 2 to 8) TiSiO monolayers in a TiO2 material between every 100 to 150 monolayers of TiO2 can reduce the overall stress of the material stack. Without wishing to be bound by theory, it is believed that a correctly chosen strain in layers 304a, 304b, 304c, and 304d can reduce the tendency of the titanium oxide layers 302a, 302b, 302c, and 302d to crystallize. Without wishing to be bound by theory, it is believed that a correctly chosen compressive strain in the layers 304a, 304b, 304c, and 304d and a correctly chosen tensile strain in the layers 302a, 302b, 302c, and 302d can result in a substantially relaxed material stack.

In some embodiments, the thickness of the titanium oxide layers 302a, 302b, 302c and/or the thickness of layers 304a, 304b, 304c, and 304d can vary as a function of distance from the surface of the substrate. By varying the thickness of the titanium oxide layers 302a, 302b, 302c and/or the thickness of layers 304a, 304b, 304c, and 304d a material with a varying index of refraction can be formed.

For example, in certain embodiments, the thickness of layers 304a, 304b, 304c, and 304d is constant and the thickness of the titanium oxide layers 302a, 302b, 302c increases as a function of distance from the substrate. This results in an increasing index of refraction. In certain additional embodiments, the thickness of the thickness of layers 304a, 304b, 304c, and 304d is constant and the thickness of the titanium oxide layers 302a, 302b, 302c decreases as a function of distance from the substrate. This results in a decreasing index of refraction.

In certain embodiments, the thickness of the titanium oxide layers 302a, 302b, and 302c is constant and the thickness of layers 304a, 304b, 304c, and 304d increases as a function of distance from the substrate. This results in a decreasing index of refraction. In certain additional embodiments, the thickness of the titanium oxide layers 302a, 302b, 302c is constant and the thickness of layers 304a, 304b, 304c, and 304d decreases as a function of distance from the substrate. This results in an increasing index of refraction.

While in the embodiments described above in relation to FIG. 8 a certain number of layers of a material containing titanium, silicon and oxygen and titanium oxide have been described, more generally, a material can have one or more layers (e.g., 2 layers, 3 layers, 4 layers, 5 layers, 6 layers, 7 layers, 8 layers, 9 layers, 10 layers, 11 layers, 12 layers, 13 layers, 14 layers, 15 layers, 20 layers, 25 layers, 30 layers). Typically, the number of layers of a multilayer stack is selected based on the desired optical properties of the material. In some embodiments, a multilayer stack may include more than 15 layers (e.g., about 20 layers or more, about 30 layers or more, about 40 layers or more, about 50 layers or more).

While in the embodiments described above in relation to FIG. 8, multi-layer stack 300 was comprised of alternating layers of titanium oxide (e.g., layers 302a, 302b, 302c) and layers of a material containing titanium, silicon and oxygen (e.g., layers 304a, 304b, 304c, and 304d), a material stack could be formed of alternating layers of other materials. In some embodiments, the material stack could be formed of alternating layers of titanium oxide and silicon oxide. For example, the material stack could include layers of silicon oxide having a thickness of from about 0.3 nm to about 1 nm (e.g., about 0.4 nm, about 0.5 nm, about 0.6 nm, about 0.7 nm, about 0.8 nm, about 0.9 nm, about 1.0 nm) and layers of titanium oxide having a thickness from about 10 nm to about 100 nm (e.g., about 20 nm, about 30 nm, about 40 nm, about 50 nm, about 60 nm, about 70 nm, about 80 nm, about 90 nm, about 100 nm).

While in the embodiments described above, a material containing titanium, silicon and oxygen has been described as being formed of a titanium oxide in which some of the titanium has been substituted by silicon to form the material, other materials can be formed using a similar process. In general, the refractive index and/or material properties of a metal oxide can be altered by selectively substituting at least some of the metal atoms with silicon atoms. Exemplary metal oxides include hafnium oxide, aluminum oxide, niobium oxide, zirconium oxide, tantalum oxide, magnesium oxide, neodymium oxide, tin oxide, vanadium oxide, yttrium oxide. The index of refraction of the silicates of hafnium, aluminum, niobium, zirconium, tantalum, magnesium, neodymium, tin, vanadium, and yttrium formed when some of the metal atoms are substituted by silicon atoms can vary between the index of refraction of silicon oxide and the index of refraction of the metal oxide.

In some embodiments, a third material atom is introduced into the material containing silicon, titanium, and oxygen. For example if a material with higher oxidation state such as tantalum (or niobium) is introduced (in Ta2O5 the oxidation state of tantalum is 5) as a partial substitute to some of the titanium or silicon of the material containing titanium, silicon and oxygen then the material intrinsic stress properties can be additionally modified by the presence of the additional excess electronic bond. Therefore by using silicon substitution of titanium atoms optical properties of the material can be tailored, and by using tantalum or niobium substitution of titanium atoms intrinsic stress properties of the material can be modified.

The materials described above can be used to form various optical articles. For example, in some embodiments, the substrate can include one or more structured surface that is coated with a material using ALD. Referring to FIG. 9, an example of a structured surface is a surface 520 of a Fresnel lens 501. ALD can be used to deposit a material 510 (e.g., a single layer or multi layer stack) on slopes 521 and drafts 522 of surface 520. The conformal nature of the ALD process results in material 510 having substantially uniform thickness on both slopes 521 and drafts 522. In some embodiments, material 510 is an antireflection material, which can reduce (e.g., eliminate) ghosting effects that may otherwise be experienced during use of the lens.

Other examples of structured surfaces that may be coated using ALD include grating structures, such as ruled gratings and surface relief gratings, cylindrical surfaces, such as the surface of an optical fiber or an inner surface of a hollow waveguide (e.g., having a circular, square or rectangular cross section). A further example is a cleaved surface of an optical fiber. For example, some telecommunications applications utilize design schemes in which a cleaved fiber is positioned very close to a lens or an optical article. Coating an AR material onto a cleaved surface using ALD can reduce reflections at the surface. Multiple cleaved surfaces can be coated in a single ALD run.

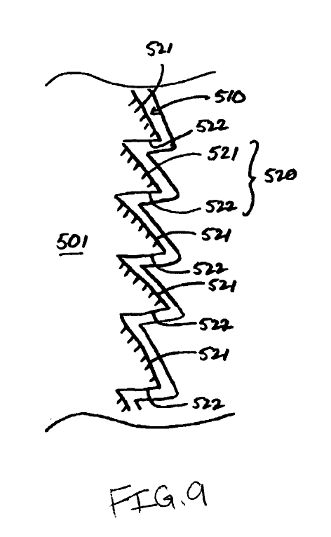

Optical articles formed using the methods disclosed herein can be used in a variety of optical systems. Referring to FIG. 10, in some embodiments, an IR filter 610 formed using ALD techniques is used in an imaging system 600. Imaging system includes lenses 620 and 630 which image EM radiation propagating relative to axis 660 admitted through an aperture 640 onto a detector 650 (e.g., a charge coupled device (CCD) or complementary metal oxide semiconductor (CMOS) detector) at an image plane. IR filter 610 is positioned between lens 620 and detector 650. IR filter 610 includes multilayer stacks 611 and 612, and reduces (e.g., substantially eliminates) the amount of IR EM radiation admitted through aperture 640 that impinges on detector 650. For example, IR filter can reduce the amount of EM radiation at a block wavelength by about 20% or more (e.g., about 50% or more, about 80% or more, about 90% or more, about 95% or more).

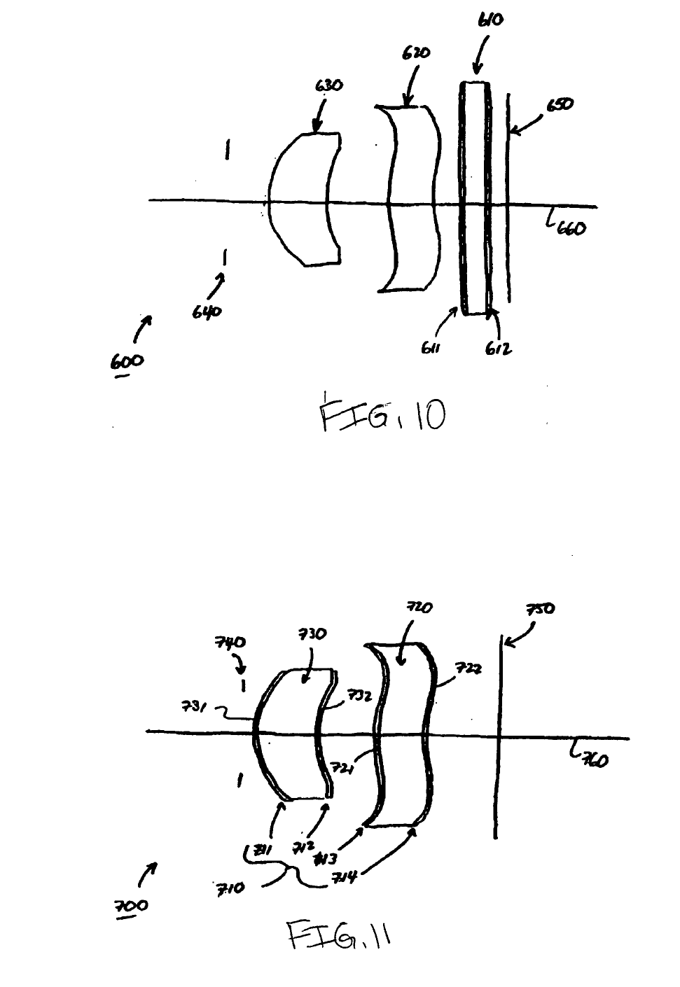

In some embodiments, ALD may be used to integrate optical articles in an optical system. For example, discrete IR filter 610 in imaging system 600 can be replaced with a filter coated directly onto one or more surfaces of the lenses in an imaging system. For example, referring to FIG. 11, an imaging system 700 includes a pair of lenses 720 and 730, which image EM radiation propagating relative to axis 760 admitted through an aperture 740 onto a detector 750. An optical filter 710 includes multilayer stacks 713, 714, 711, and 712 deposited on surfaces 721, 722, 731, and 732 of lenses 720 and 730, respectively. Like IR filter 610 shown in FIG. 6, optical filter 710 reduces (e.g., substantially eliminates) the amount of IR EM radiation admitted through aperture 740 that impinges on detector 750.

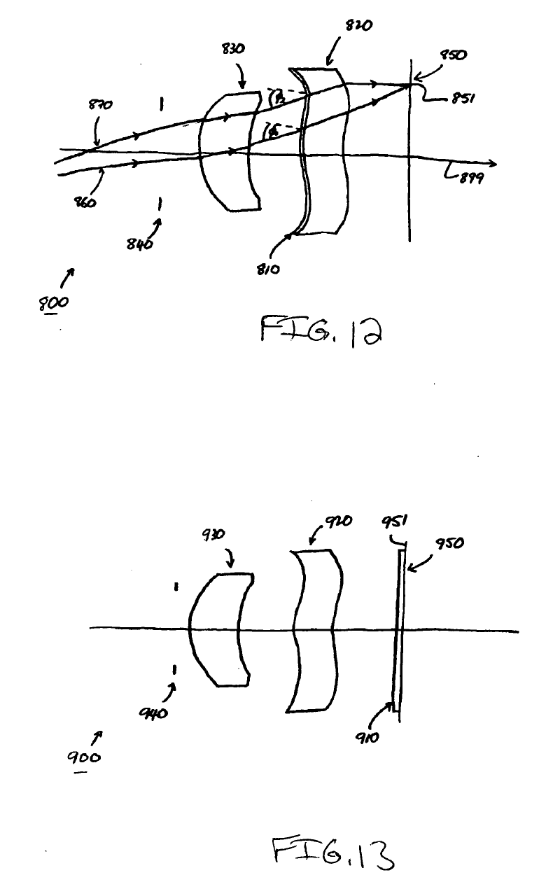

In a further embodiment, FIG. 12 shows an imaging system 800 including an IR filter 810, which is deposited on a single surface 821 of a lens 820. Imaging system 800 also includes a second lens 830, a detector 850, and an aperture 840. Lenses 820 and 830 image EM radiation admitted through aperture 840 onto detector 850. Surface 821 corresponds to the lens surface where the divergence of imaged rays is smallest. In other words, a maximum difference in the propagating direction of imaged rays is less than a maximum difference in the propagation direction of imaged rays at other surfaces of lenses 720 and 730. Accordingly, the maximum blue shift associated with the band edge of the filter is less when the filter is located on surface 810 than it would be if located on other surfaces in imaging system 800.

Ray divergence is illustrated by rays 860 and 870, which originate from a common source point and are imaged to a common point 851 on detector 850. The propagation angles of rays 860 and 870 with respect to an optical axis 899 of imaging system 800 are Φ1 and Φ2, respectively. The divergence of the rays is the difference between Φ1 and Φ2. In some embodiments, rays of imaged EM radiation have a maximum divergence of about 20 degrees or less at IR filter 810 (e.g., about 15 degrees or less, about 10 degrees or less, about 8 degrees or less). Accordingly, the blue shift experienced by the system's marginal rays compared to rays propagating along axis 899 can be about 20 nm or less (e.g., about 15 nm or less, about 12 nm or less, about 10 nm or less).

In another embodiment, FIG. 13 shows an imaging system 900 including an IR filter 910, which is deposited on a surface 951 of a detector 950 (e.g., a CCD or CMOS detector). Imaging system 900 also includes a lens 920, a second lens 930, and an aperture 940. Lenses 920 and 930 image EM radiation admitted through aperture 940 onto detector 950.

While particular examples of optical articles have been described above, oxide materials as described herein can be used in other optical articles. Examples of such optical articles include thin film interference filters, absorption filters, wire grid light polarizing structures, rugate filters, conformal filling of three-dimensional structures (e.g., trenches, diffraction grating grooves), conformal material growth on three-dimensional template structures (e.g., pillars, pyramids, columns, semi-spheres), optical lens structures, interface layers between different parts of an integrated optical component.

Imaging systems, such as those discussed previously, may be used in electronic devices, such as digital cameras and digital camcorders. In some embodiments, the imaging systems may be used in digital cameras in cellular telephones.

The following examples are illustrative and not intended as limiting.

### EXAMPLES

### Example I

### Material Containing Titanium, Silicon and Oxygen—Titanium Silicate

A material was formed by depositing a material on a SBSL 7 type of substrate, which was obtained from Ohara Corporation. The material was a layer of material containing titanium, silicon and oxygen in having about equal amounts of titanium and silicon.

To deposit the material, the substrate was placed in an ALD reaction chamber. Air was purged from the chamber. Nitrogen was flowed through the chamber, maintaining the chamber pressure at about 0.5 Torr. The chamber temperature was set to 300° C. and left for about 2 hours for the substrate to thermally equilibrate. Once thermal equilibrium was reached, the valve to the TiCl4 was opened for 0.5 seconds, introducing TiCl4 into the chamber. The chamber was allowed to purge by the nitrogen flow for 2 seconds before the valve to the tris(tert-butoxy)silanol was opened for 1.2 seconds, introducing Silanol into the chamber. The chamber was then allowed to purge for 2 seconds. This cycle of a dose of TiCl4, followed by a dose of Silanol was repeatedly introduced, resulting in a layer of material containing titanium, silicon and oxygen being formed on the exposed surfaces of the substrate. No additional oxygen delivering precursor was used. This cycle was repeated 1000 times, resulting in a material containing titanium, silicon and oxygen layer having a thickness of about 100 nm.

### Example II

### TiO2 Material Laminated With Titanium Silicates

A multilayer stack of materials was formed by depositing multilayer stacks on SBSL 7 type of substrate, which was obtained from Ohara Corporation. The multilayer stack of materials included alternating layers of a high index material and a lower index material (e.g., as shown schematically in FIG. 8). The high index material was TiO2 and the lower index material was a material containing titanium, silicon and oxygen. The precursor for the titanium oxide was TiCl4, obtained from Sigma-Aldrich. The precursors for the material containing titanium, silicon and oxygen were TiCl4 and tris(tert-butoxy)silanol, obtained from Sigma-Aldrich For TiO2 bulk material layers the reagent was de-ionized water.

To deposit the material, the substrate was placed in an ALD reaction chamber. Air was purged from the chamber. Nitrogen was flowed through the chamber, maintaining the chamber pressure at about 0.5 Torr. The chamber temperature was set to 300° C. and left for about 2 hours for the substrate to thermally equilibrate. Once thermal equilibrium was reached, an initial pulse of water vapor was introduced into the chamber by opening the valve to the water supply for 1 second. After the valve to the water supply was closed, the chamber was purged by the nitrogen flow for 2 seconds. Next, the valve to the TiCl4 was opened for 0.4 seconds, introducing TiCl4 into the chamber. The chamber was again allowed to purge by the nitrogen flow for 2 seconds before another dose of water vapor was introduced. Alternating doses of water vapor and TiCl4 were introduced between purges, resulting in a layer of TiO2 being formed on the exposed surfaces of the substrate. This cycle was repeated 200 times, resulting in TiO2 layer having a thickness of 8 nm

Subsequently, a pulse of TiCl4 was introduced into the chamber by opening the valve to the TiCl4 was opened for 0.5 seconds. The chamber was again allowed to purge by the nitrogen flow for 2 seconds before the valve to the tris(tert-butoxy)silanol was opened for 1.2 seconds, introducing Silanol into the chamber. The chamber was purged for 2 seconds after that. This cycle of a dose of TiCl4, followed by a dose of Silanol was repeatedly introduced, resulting in a layer of material containing titanium, silicon and oxygen being formed on the exposed surfaces of the substrate. This cycle was repeated 6 times, resulting in a 0.6 nm thick layer of a material containing titanium, silicon and oxygen being formed on the titanium layer.

Additional layers of titanium oxide and a material containing titanium, silicon and oxygen were deposited using the steps outlined above to provide a multilayer stack on the exposed substrate surfaces. The thickness of each layer and number of deposition cycles used to deposit each layer are summarized in Tables I-III.

TABLE I
(2.4% TiSiO).

| TiO₂ Layers | | | TiSiO₂ Layers | | |
|---|---|---|---|---|---|
| | Thickness | No. | | Thickness | No. |
| Layer No. | (nm) | of Cycles | Layer No. | (nm) | of Cycles |
| 1 | TiO2 | 250 | 2 | TiSiO | 6 |
| 3 | TiO2 | 250 | 4 | TiSiO | 6 |
| 5 | TiO2 | 250 | 6 | TiSiO | 6 |
| 7 | TiO2 | 250 | 8 | TiSiO | 6 |
| 9 | TiO2 | 250 | 10 | TiSiO | 6 |
| 11 | TiO2 | 250 | 12 | TiSiO | 6 |

TABLE II
(3% TiSiO).

| TiO₂ Layers | | | TiSiO₂ Layers | | |
|---|---|---|---|---|---|
| | Thickness | No. | | Thickness | No. |
| Layer No. | (nm) | of Cycles | Layer No. | (nm) | of Cycles |
| 1 | TiO2 | 200 | 2 | TiSiO | 6 |
| 3 | TiO2 | 200 | 4 | TiSiO | 6 |
| 5 | TiO2 | 200 | 6 | TiSiO | 6 |
| 7 | TiO2 | 200 | 8 | TiSiO | 6 |
| 9 | TiO2 | 200 | 10 | TiSiO | 6 |
| 11 | TiO2 | 200 | 12 | TiSiO | 6 |

TABLE III
(5.5% TiSiO).

| TiO₂ Layers | | | TiSiO₂ Layers | | |
|---|---|---|---|---|---|
| | Thickness | No. | | Thickness | No. |
| Layer No. | (nm) | of Cycles | Layer No. | (nm) | of Cycles |
| 1 | TiO2 | 110 | 2 | TiSiO | 6 |
| 3 | TiO2 | 110 | 4 | TiSiO | 6 |
| 5 | TiO2 | 110 | 6 | TiSiO | 6 |
| 7 | TiO2 | 110 | 8 | TiSiO | 6 |
| 9 | TiO2 | 110 | 10 | TiSiO | 6 |
| 11 | TiO2 | 110 | 12 | TiSiO | 6 |
| 13 | TiO2 | 110 | | | |

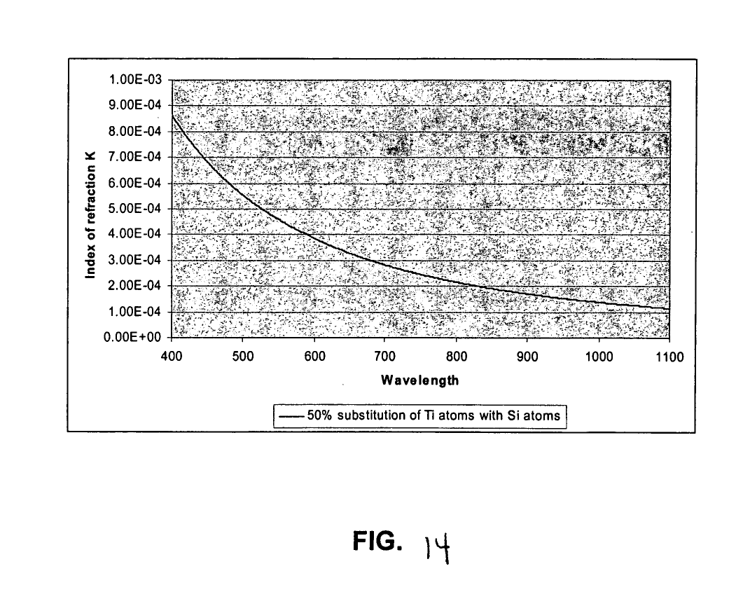

Referring to FIG. 14, the performance of the optical material was investigated. FIG. 14 shows the imaginary index of refraction K. The low values of the imaginary index of refraction show that the material exhibits low material absorption and scattering. Based on the low material absorption, it is believed that the material is substantially amorphous.

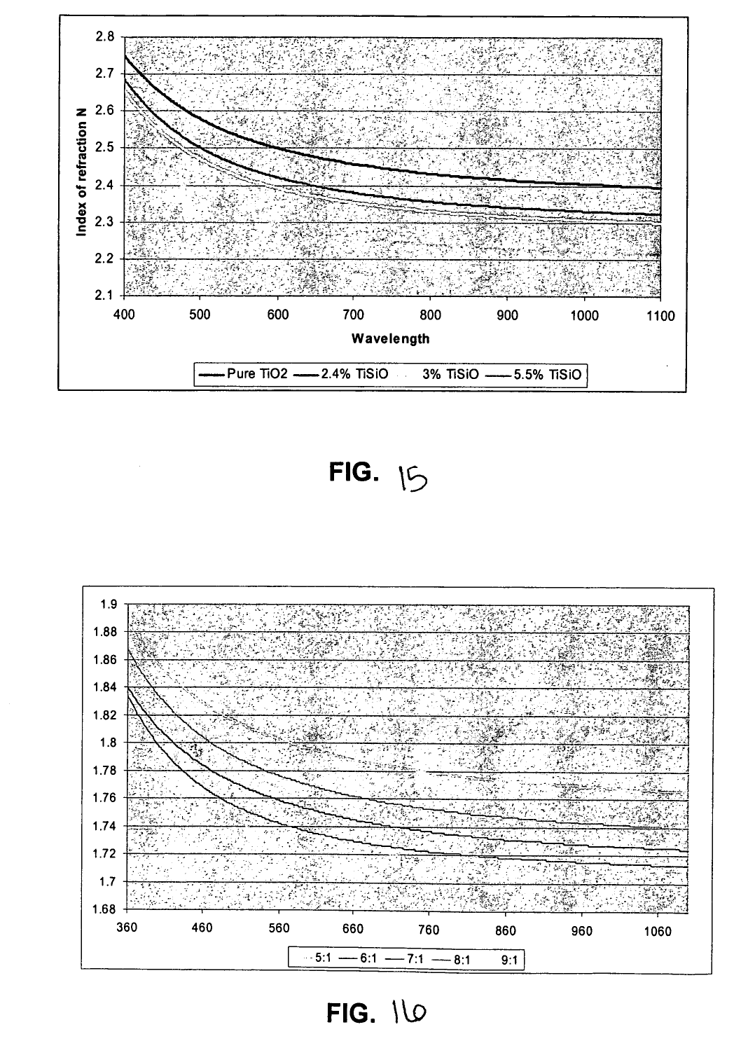

Referring to FIG. 15, the index of refraction of the multilayer stacks comprised of 0%, 2.4%, 3%, and 5.5% of a material containing titanium, silicon and oxygen was measured at wavelengths between 400 nm and 1100 nm. FIG. 15 shows the index of refraction for the multilayer stacks of titanium oxide and material containing silicon, titanium, and oxygen with different percentages of material containing silicon, titanium, and oxygen. The measured index of refraction for the various multilayer stacks is summarized in Table IV.

TABLE IV

| | | Index | Index | Index |
|---|---|---|---|---|
| | Index | of | of | of |
| Wave- | of refraction | refraction | refraction | refraction |
| length | (pure TiO2) | (2.4% TiSiO) | (3% TiSiO) | (5.5% TiSiO) |
| 400 | 2.75 | 2.687 | 2.656 | 2.656 |
| 500 | 2.578 | 2.501 | 2.47 | 2.37 |
| 600 | 2.5 | 2.421 | 2.392 | 2.296 |
| 700 | 2.458 | 2.38 | 2.352 | 2.26 |
| 800 | 2.432 | 2.356 | 2.33 | 2.24 |
| 900 | 2.416 | 2.341 | 2.316 | 2.228 |
| 1000 | 2.405 | 2.331 | 2.306 | 2.22 |
| 1100 | 2.397 | 2.324 | 2.3 | 2.214 |

### Example III

### Process For Fine Tuning the Index of Refraction of a Material

A material was formed by depositing a material on a SBSL 7 type of substrate, which was obtained from Ohara Corporation. To deposit the material, the substrate was placed in an ALD reaction chamber. Air was purged from the chamber. Nitrogen was flowed through the chamber, maintaining the chamber pressure at about 0.5 Torr. The chamber temperature was set to 300 and left for about 2 hours for the substrate to thermally equilibrate. Once thermal equilibrium was reached, an initial pulse of water vapor was introduced into the chamber by opening the valve to the water supply for 1 seconds. After the valve to the water supply was closed, the chamber was purged by the nitrogen flow for 2 seconds. Next, the valve to the TiCl4 was opened for 0.5 seconds, introducing TiCl4 into the chamber. The chamber was again allowed to purge by the nitrogen flow for 2 seconds before another dose of water vapor was introduced. This cycle of providing an oxygen precursor followed by a titanium precursor was repeated for a predetermined number of times (as shown in FIG. 16, for different materials the cycle was repeated 5, 6, 7, 8, or 9 times). After repeating the oxygen/titanium cycle for the predetermined number of times, water vapor was introduced into the chamber by opening the valve to the water supply for 1 second. After the valve to the water supply was closed, the chamber was purged by the nitrogen flow for 2 seconds. Next, the valve to the tris(tert-butoxy)silanol was opened for 1.2 seconds, introducing Silanol into the chamber. Additional layers were deposited using the steps outlined above to provide multilayer stacks on the exposed substrate surfaces.

Referring to FIG. 16, the index of refraction of the multilayer stacks were investigated using ellipsometry. The index of refraction was measured at wavelengths between 400 nm and 1100 nm. FIG. 16 shows the index of refraction for the material with different ratios of titanium to silicon cycles (e.g., the ratio of TiO2:HSiO cycles). For example a ratio of 5:1 would indicate a repetition of following sequence: oxygen precursor+titanium precursor+oxygen precursor+titanium precursor+oxygen precursor+titanium precursor+oxygen precursor+titanium precursor+oxygen precursor+titanium precursor+oxygen precursor+silicon precursor. Refractive index tuning is possible by incrementing the TiO2 cycles by 1.

As shown in FIG. 16, as the ratio of TiO2 to HSiO cycles increases, the refractive index of the resulting material increases. The measured index of refraction is summarized in Table V.

TABLE V

| | Index of | Index of | Index of | Index of | Index of |
|---|---|---|---|---|---|
| | refraction | refraction | refraction | refraction | refraction |
| Wavelength | (5:1) | (6:1) | (7:1) | (8:1) | (9:1) |
| 400 | 1.771 | 1.799 | 1.811 | 1.835 | 1.857 |
| 500 | 1.743 | 1.755 | 1.772 | 1.791 | 1.816 |
| 600 | 1.729 | 1.736 | 1.752 | 1.769 | 1.796 |
| 700 | 1.721 | 1.726 | 1.741 | 1.758 | 1.784 |
| 800 | 1.716 | 1.721 | 1.734 | 1.75 | 1.777 |
| 900 | 1.712 | 1.717 | 1.73 | 1.746 | 1.772 |
| 1000 | 1.709 | 1.714 | 1.727 | 1.742 | 1.768 |
| 1100 | 1.708 | 1.713 | 1.724 | 1.74 | 1.765 |

Other embodiments are in the claims.

1. An oxide comprising silicon and a metal, wherein the oxide has a refractive index of at least about 1.8 at a wavelength of 632 nm.

2. (canceled)

3. The oxide of claim 1, wherein the oxide has a refractive index of at least about 2.2 at a wavelength of 632 nm.

4. The oxide of claim 1, wherein the oxide has a refractive index of at most about 2.5 at a wavelength of 632 nm.

5. The oxide of claim 1, wherein the metal is selected from the group consisting of titanium, hafnium, aluminum, niobium, zirconium, tantalum, magnesium, neodymium, tin, vanadium, and yttrium.

6. The oxide of claim 1, wherein the metal comprises titanium

7. (canceled)

8. The oxide of claim 1, wherein the oxide comprises at least about five atomic percent silicon.

9. (canceled)

10. The oxide of claim 1, wherein the oxide comprises at most about ten atomic percent silicon.

11-12. (canceled)

13. The oxide of claim 1, wherein the oxide comprises at least about twenty-five atomic percent of the metal.

14-15. (canceled)

16. The oxide of claim 1, wherein:
the metal comprises titanium;
the oxide comprises at least about fifteen atomic percent titanium; and
the oxide comprises at least about one atomic percent silicon.

17. The oxide of claim 16, wherein the oxide comprises at most about thirty atomic percent titanium.

18. The oxide of claim 17, wherein the oxide comprises at most about ten atomic percent silicon.

19-24. (canceled)

25. The oxide of claim 1, wherein the oxide is at least about 90 percent amorphous.

26-29. (canceled)

30. The oxide of claim 1, wherein:
the oxide has a thickness defined by first and second surfaces;
the oxide includes a first portion partially defined by the first surface of the oxide;
the oxide includes a second portion partially defined by the second surface of the oxide;
the first portion is different from the second portion;
the first portion has a first average atomic percentage of silicon that is greater than zero;
the second portion has a second average atomic percentage of silicon that is greater than zero; and
the second average atomic percentage is different from the first average atomic percentage of silicon.

31. (canceled)

32. The oxide of claim 1, wherein:
the oxide has a thickness defined by first and second surfaces;
the oxide includes a first portion partially defined by the first surface of the oxide;
the oxide includes a second portion partially defined by the second surface of the oxide;
the first portion is different from the second portion;
the first portion has a first average atomic percentage of silicon that is equal to zero;
the second portion has a second average atomic percentage of silicon that is greater than zero.

33-35. (canceled)

36. The oxide of claim 1, wherein:
the oxide has a thickness defined by first and second surfaces;
the oxide includes a first portion partially defined by the first surface of the oxide;
the oxide includes a second portion partially defined by the second surface of the oxide;
the first portion is different from the second portion;
the first portion has a first average atomic percentage of silicon;
the second portion has a second average atomic percentage of silicon; and
the second average atomic percentage is different from the first average atomic percentage of silicon.

37-39. (canceled)

40. An oxide compound that comprises at least about one atomic percent silicon and at least about twenty atomic percent of a metal.

41. (canceled)

42. The oxide of claim 40, wherein the metal comprises titanium

43-49. (canceled)

50. The oxide of claim 40, wherein:
the metal comprises titanium;
the oxide comprises at least about fifteen atomic percent titanium; and
the oxide comprises at least about one atomic percent silicon.

51. The oxide of claim 50, wherein the oxide comprises at most about thirty atomic percent titanium.

52. The oxide of claim 51, wherein the oxide comprises at most about ten atomic percent silicon.

53-63. (canceled)

64. The oxide of claim 40, wherein:
the oxide has a thickness defined by first and second surfaces;
the oxide includes a first portion partially defined by the first surface of the oxide;
the oxide includes a second portion partially defined by the second surface of the oxide;
the first portion is different from the second portion;
the first portion has a first average atomic percentage of silicon that is greater than zero;
the second portion has a second average atomic percentage of silicon that is greater than zero; and
the second average atomic percentage is different from the first average atomic percentage of silicon.

65-69. (canceled)

70. The oxide of claim 40, wherein the oxide has a refractive index of at least about 1.8 at a wavelength of 632 nm.

71-101. (canceled)

102. An article, comprising:
a first layer, the first layer comprising of titanium oxide; and
a second layer, the second layer comprising an oxide comprising titanium and silicon.

103. The article of claim 102, further comprising:
a third layer supported by the second layer, the third layer comprising of titanium oxide;
a fourth layer supported by the third layer, the fourth layer comprising an oxide comprising titanium and silicon.
a fifth layer supported by the fourth layer, the fifth layer comprising of titanium oxide; and
a sixth layer supported by the fifth layer, the sixth layer comprising an oxide comprising titanium and silicon.

104-115. (canceled)

116. The article of claim 103, wherein:
the first layer has a first thickness,
the second layer has a second thickness;
the third layer has a third thickness, the third thickness being greater than the first thickness;
the fourth layer has a fourth thickness, the fourth thickness being about the same as the second thickness;
the fifth layer has a fifth thickness, the fifth thickness being greater than the third thickness;
the sixth layer has a sixth thickness, the sixth thickness being about the same as the second thickness.

117. The article of claim 106, wherein:
the first layer has a first thickness,
the second layer has a second thickness;
the third layer has a third thickness, the third thickness being less than the first thickness;
the fourth layer has a fourth thickness, the fourth thickness being about the same as the second thickness;
the fifth layer has a fifth thickness, the fifth thickness being less than the third thickness;
the sixth layer has a sixth thickness, the sixth thickness being about the same as the second thickness.

118-145. (canceled)

146. An article, comprising:
a substrate; and
a layer of an oxide supported by the substrate, the oxide comprising silicon and a metal, the oxide having a refractive index greater than a refractive index of silicon oxide and less than a refractive index of metal oxide,
wherein the article is an optical element.

147. The article of claim 146, wherein the optical component is selected from the group consisting of thin film interference filters, absorption filters, wire grid light polarizing structures, rugate filters, conformal filling of a three-dimensional structure, conformal film growth on a three-dimensional template structure, optical lens structures, interface layers between different parts of an integrated optical component.

148-156. (canceled)

157. The article of claim 146, wherein:
the metal comprises titanium;
the oxide comprises at least about fifteen atomic percent titanium; and
the oxide comprises at least about one atomic percent silicon.

158-206. (canceled)
